(19) United States
(12) Patent Application Publication
(10) Pub. No.: US 2008/0067206 A1
(43) Pub. Date: Mar. 20, 2008

(54) Storage system

(76) Inventor: Todd Kuhn, North East, MD (US)

Correspondence Address: Todd Kuhn, 171 Springfield Drive S., North East, MD, 21901, US

(21) Appl. No.: 11/521,229

(22) Filed: Sep. 15, 2006

(51) Int. Cl. B60R 7/00; A01K 97/06; B60R 9/00

(52) U.S. Cl. 224/406; 224/400; 43/54.1

(57) ABSTRACT

The invention is a storage system that can be easily stowed inside a vehicle or securely, and removably, mounted to a surface of the vehicle. The storage system includes a means for securing the storage system to the vehicle surface and a low profile which enables the storage system to be deployed while presenting a minimum inconvenience or hazard for the user who may be preoccupied with other activities.

### BACKGROUND OF THE INVENTION

1. Field of the Invention

The present invention relates generally to the field of systems used to store small objects. Specifically, the invention relates to systems comprising compartmentalized containers or boxes used for the storage and management of small objects, such as fishing tackle, wherein the entire system may be transported and removably mounted to one or more work surfaces. However, the present invention is not restricted to fishing tackle. In alternate embodiments, the present invention relates to a system that stores small objects associated with all-terrain vehicles, snowmobiles, recreational vehicles, motorcycles, and other recreational, household, and commercial applications.

2. Description of the Prior Art

Contemporary fishing is an enterprise that requires a considerable amount of equipment. Gone are the days of a simple cane pole outfitted with line, float, and hook. The typical fisherman today brings with him a variety of lures, hooks, swivels, weights, and assorted tools. Tournament fishermen represent the pinnacle of this need, often bringing with them thousands of individual lure bodies with multiple interchangeable parts of every conceivable size, shape, configuration, and color. Their livelihood depends upon their ability to catch as many fish as possible. Having a large diversity of tackle from which to choose can provide a competitive advantage while out on the water.

Historically such tackle has been stored in a traditional tackle box. It is well known in the art to provide portable, closable, tackle boxes with a variety of compartments. Some such prior art boxes are complex designs with multiple, hinged trays and bins. They also include handles for transporting the boxes from one location to another.

A significant universal disadvantage in prior art tackle boxes is the fact that they must remain stowed in a cargo area of the boat and then deployed only temporarily when needed. Otherwise, a deployed prior art box may inadvertently slide overboard or be tripped upon by an angler whose attention is focused on battling a fish. This is an acute problem for tournament fishermen. A typical tournament boat is dominated by a large, flat deck to which one or more elevated chairs are attached. Fishermen traverse the length of this deck while actively fishing. Prior art tackle boxes either slide perilously around on deck or are relegated to storage compartments. What is needed is a storage system that can be stowed or mounted solidly to the deck without creating a considerable trip hazard for the fisherman.

Other prior art storage systems outside of the fishing art are equally deficient in their ability to provide a removable, transportable means for organizing small objects. Storage systems for vehicles such as automobiles, all-terrain vehicles, snowmobiles, recreational vehicles, and motorcycles are typically designed for stationary service, such as a common tool box, and perilously attached using rope or elastic bands to prevent unintended movement.

### SUMMARY OF THE INVENTION

The present invention is a storage system that can be easily stowed inside a vehicle, such as a boat, or securely, and removably, mounted to a surface of the vehicle, such as a boat deck, console, gunnel, or transom. A key feature of the present invention is the means for securing the storage system to the vehicle surface. Another key feature is the geometry of the present invention. A low profile enables the storage system to be deployed while presenting a minimum inconvenience or hazard for the user, such as a fisherman who is otherwise preoccupied with fishing or an all-terrain vehicle rider who is otherwise preoccupied with driving his vehicle.

### BRIEF DESCRIPTION OF THE DRAWINGS

FIG. 1 shows an oblique perspective of a first embodiment of the storage system of the present invention in the closed position.

FIG. 2 shows another oblique perspective of a first embodiment of the storage system of the present invention in the closed position.

FIG. 3 shows a rear view of a first embodiment of the storage system of the present invention.

FIG. 4 shows a detailed view of the mounting means of a first embodiment of the storage system of the present invention.

FIG. 5 shows a detailed view of the handle means of a first embodiment of the storage system of the present invention.

FIG. 6 shows an exploded oblique view of a first embodiment of the storage system of the present invention.

FIG. 7 shows an oblique perspective of a first embodiment of the storage system of the present invention in the open position.

FIG. 8 shows an oblique perspective of a second embodiment of the storage system of the present invention in the open position.

FIG. 9 shows a cut-away view of a second embodiment of the storage system of the present invention.

### DETAILED DESCRIPTION OF THE INVENTION

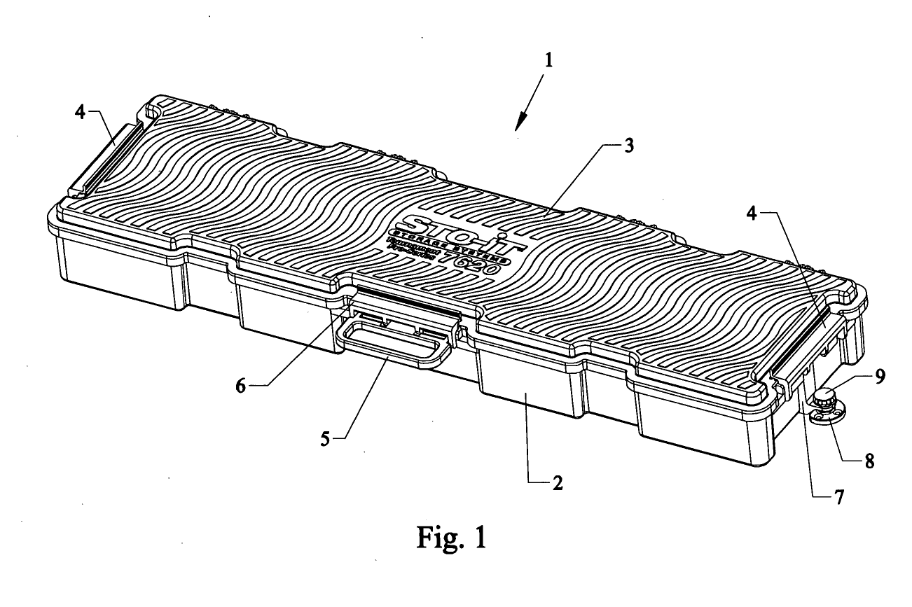

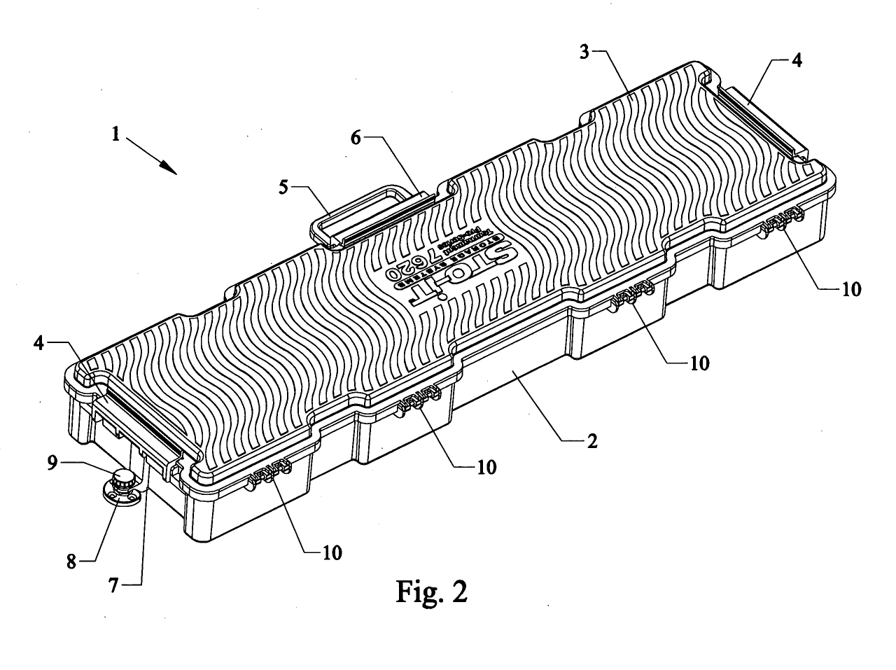

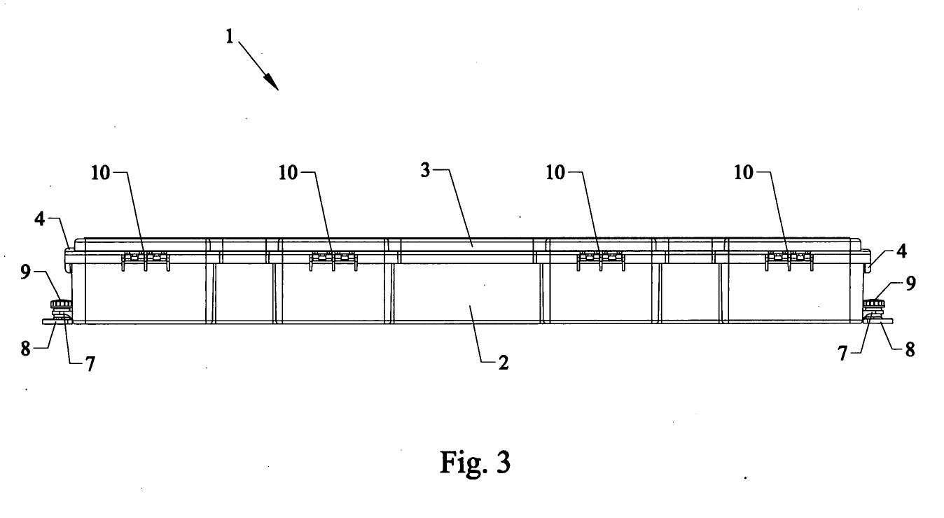

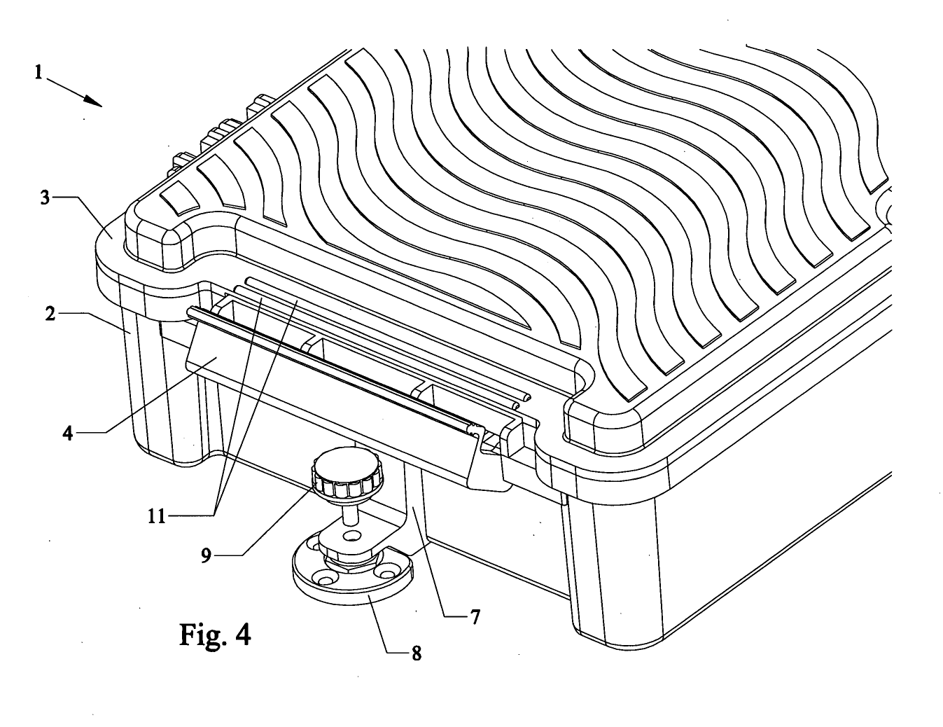

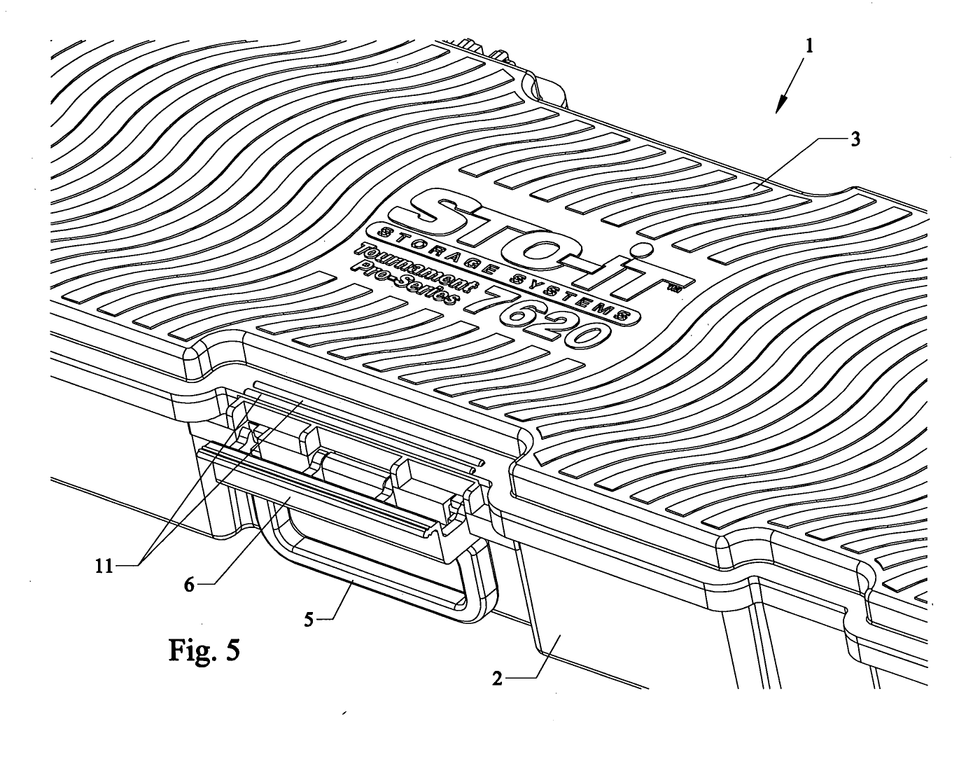

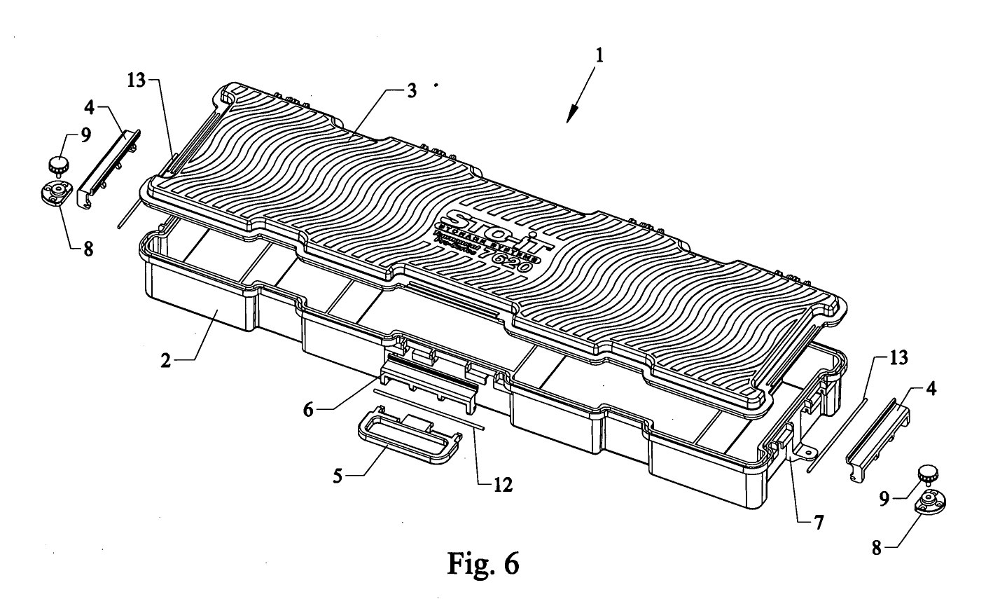

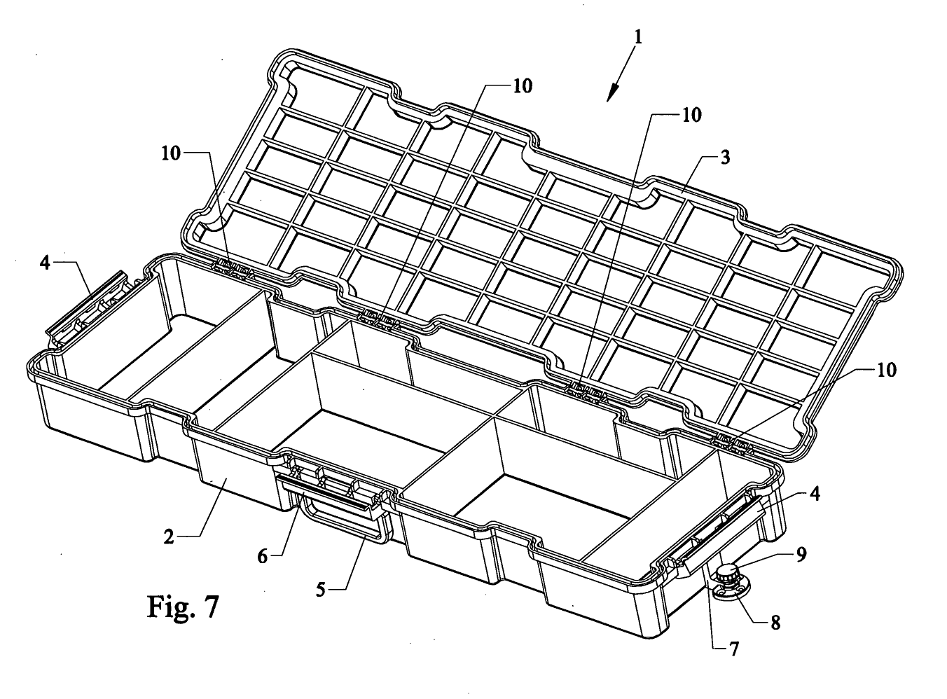

With reference to FIGS. 1 through 7, the storage system 1 of this invention comprises a base 2 and a lid 3 connected to one another along a common edge by lid hinge 10. Base 2 and lid 3 may be manufactured from any material common in the art, but they are preferably formed from thermoplastics. Plastics are preferred because of their excellent performance in the harsh environments found outdoors. Lid hinge 10 may be manufactured from metal, wood, plastic, or other materials known in the art. Base 2 and lid 3 are robustly built to even withstand the stress of being stepped upon. The underside of lid 3 may be ribbed in order to enhance structural strength. When closed, storage system 1 preferably exhibits a low profile. This reduces the potential hazard while the box is deployed on a surface such as a boat deck. Lid 3 may include optional surface features, such as the tread-like pattern shown in FIG. 1. Should a person choose to step squarely upon storage system 1, this tread-like pattern on lid 3 reduces the likelihood that he will slip and fall. Base 2 may include optional features such as subcompartments for segregating small objects like tools or tackle. These subcompompartments may be formed integrally along with base 2 by a common process such as by molding or may be separate, reconfigurable elements contained within base 2.

Lid 3 and base 2 are maintained in a closed position by at least one handle latch 6 which is located on the side of storage system 1 opposite lid hinge 10. Each handle latch 6 is connected to the upper lip of base 2 by a handle latch hinge 12 so that each handle latch 6 can rotate freely up and over top of lid 3. Lid 3 may include optional raised retention strips 11 molded into its upper surface that grip a portion of handle latch 6 when maintaining the closed position. In an alternate embodiment, retention strips 11 may be manufactured from a dissimilar material, such as silicone rubber, and attached to lid 3. Handle 5 is also attached to base 2 using the same handle latch hinge 12. In the preferred embodiment, a single handle latch 6 and its associated handle 5 are centered on the side of storage system 1 opposite lid hinge 10. This enables a user to balance and carry a storage system 1 of modest size with a single hand. In an alternate embodiment wherein storage system 1 is quite large, two handle latches 6, each with an associated handle 5, may be evenly spaced along the side of storage system 1 opposite lid hinge 10.

Storage system 1 may also include one or two end latches 4. In the preferred embodiment, one end latch 4 is located at each end of lid 3 along the edges of lid 3 that do not already include lid hinge 10 or handle 5. Each end latch 4 is connected to the upper lip of base 2 by end latch hinge 13 so that end latch 4 can rotate freely up and over top of lid 3. Lid 3 may include optional raised retention strips 11 molded into its upper surface that grip a portion of end latch 4 when maintaining the closed position. In an alternate embodiment, retention strips 11 may be manufactured from a dissimilar material, such as silicone rubber, and attached to lid 3.

The means for securing storage system 1 to the surface of a vehicle, such as a boat deck, is a key feature of the present invention. In a first embodiment of this feature, storage system 1 includes at least one attachment flange 7 integrally attached to the side of base 2. In the preferred embodiment, at least two attachment flanges 7 are spaced evenly around and integrally attached to the sides of base 2. Each attachment flange 7 extends out from the side of base 2. A mounting flange 8, corresponding to each attachment flange 7, is permanently or temporarily attached directly to the vehicle surface in such a manner that each attachment flange 7 and its corresponding mounting flange 8 are aligned when storage system 1 is deployed. Attachment flange 7 may be attached to the vehicle surface using screws, adhesives, magnets, or other means known in the art of attachment. In order to deploy storage system 1, a removable mounting fastener 9 is used to connect each attachment flange 7 to its corresponding mounting flange 8 thereby robustly securing storage system 1 to the vehicle surface. In the preferred embodiment, mounting fastener 9 comprises a thumbscrew with a knurled end. The threaded shaft of the thumbscrew engages female threads in both attachment flange 7 and mounting flange 8 to form an integral assembly.

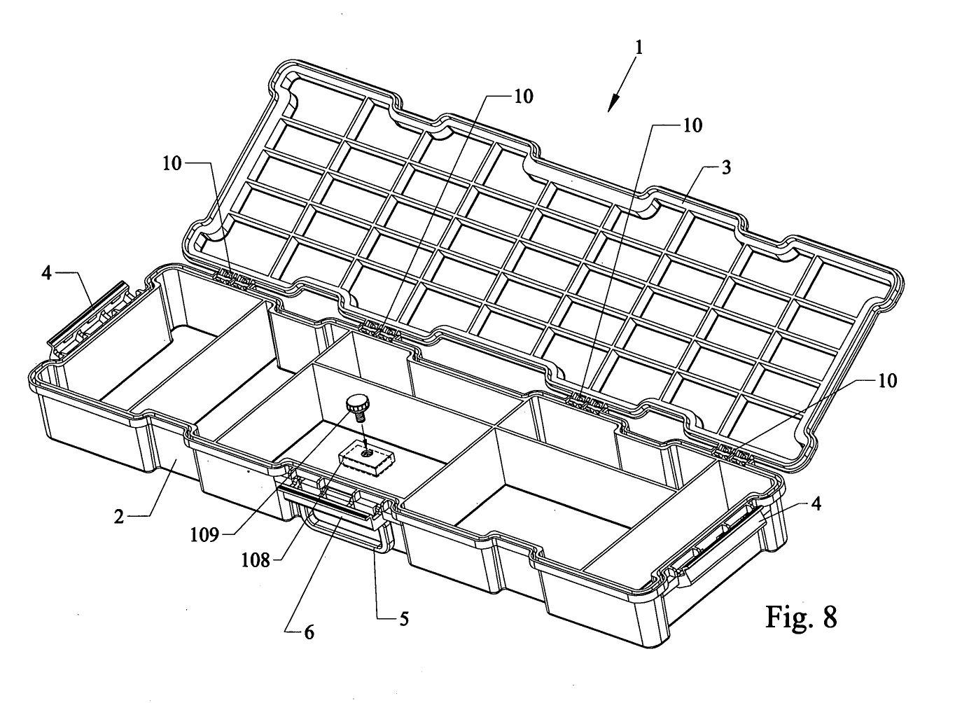

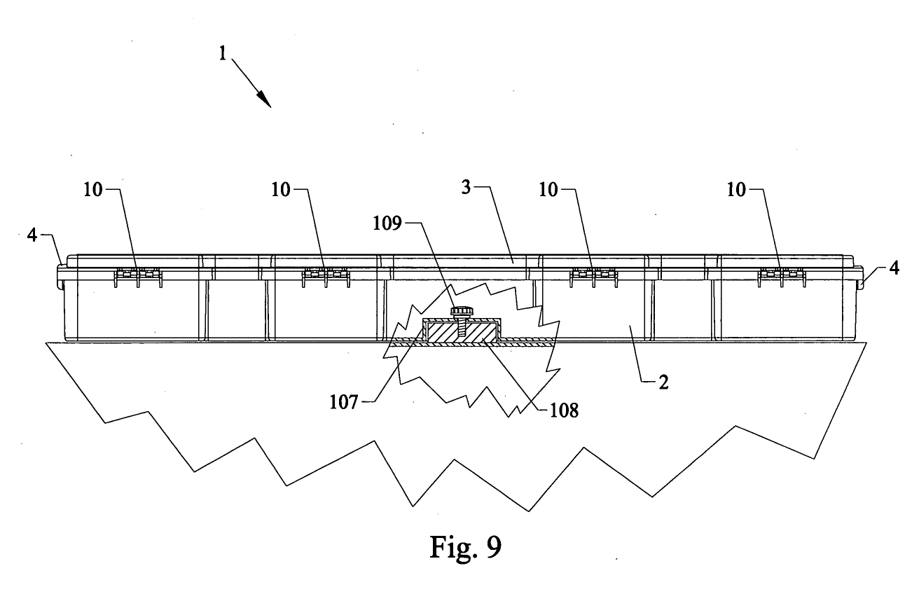

With reference to FIGS. 8 and 9, storage system 1 includes a second embodiment of the means for attaching storage system 1 to a vehicle surface. At least one attachment flange 107 is integrally attached to the bottom surface of base 2. Each attachment flange 107 may consist of a female-threaded through-hole, an integral female-threaded nut, or simply an unthreaded hole. A mounting flange 108, corresponding to each attachment flange 107, is permanently or temporarily attached directly to the vehicle surface in such a manner that each attachment flange 107 and its corresponding mounting flange 108 are aligned when storage system 1 is deployed. Attachment flange 107 may be attached to the vehicle surface using screws, adhesives, magnets, or other means known in the art of attachment. In order to deploy storage system 1, a removable mounting fastener 109 is used to connect each attachment flange 107 to its corresponding mounting flange 108 thereby robustly securing storage system 1 to the vehicle surface. In the preferred embodiment, mounting fastener 109 comprises a thumbscrew with a knurled end. The threaded shaft of the thumbscrew engages female threads in both attachment flange 107 and mounting flange 108 to form an integral assembly.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A storage system comprising:
a base; and
a lid;
wherein said base and said lid are connected along a common edge by a lid hinge;
wherein said base further includes a means for removably securing said storage system to a vehicle surface.

2. The storage system according to claim 1,
wherein said means for securing said storage system to a vehicle surface further comprises:
at least one attachment flange;
at least one mounting flange where the number of said mounting flanges is equal to the number of said attachment flanges; and
at least one removable mounting fastener where the number of said mounting fasteners is equal to the number of said attachment flanges;
wherein each said attachment flange is integrally attached to the side of said base;
wherein each said attachment flange extends out from the side of said base;
wherein all said mounting flanges are permanently or temporarily attached directly to said vehicle surface; and
wherein each said removable mounting fastener is used to connect one said attachment flange to one corresponding said mounting flange to form an integral assembly.

3. The storage system according to claim 2,
wherein said means for securing said storage system to
a vehicle surface further comprises:
at least two attachment flanges;
at least two mounting flanges where the number of said mounting flanges is equal to the number of said attachment flanges; and
at least two removable mounting fasteners where the number of said mounting fasteners is equal to the number of said attachment flanges;
wherein said attachment flanges are spaced evenly around and integrally attached to the sides of opposing ends of said base;
wherein each said attachment flange extends out from the side of said base;
wherein all said mounting flanges are permanently attached directly to said vehicle surface; and
wherein each said removable mounting fastener is used to connect one said attachment flange to one corresponding said mounting flange to form an integral assembly.

4. The storage system according to claim 2,
wherein said mounting fastener comprises a thumbscrew.

5. The storage system according to claim 2,
further comprising:
a handle; and
a handle latch;
wherein said handle latch and said handle are both located on the side of said storage system opposite said lid hinge;
wherein said handle latch and said handle are both attached to the upper lip of said base by a common handle latch hinge; and
wherein said lid and said base are maintained in a closed position by said handle latch.

6. The storage system according to claim 2,
further comprising:
two handles; and
two handle latches;
wherein said handle latches and said handles are all located on the side of said storage system opposite said lid hinge;
wherein each said handle latch and one said handle are together attached to the upper lip of said base by a common handle latch hinge; and
wherein said lid and said base are maintained in a closed position by said handle latches.

7. A storage system comprising:
a base including a means for removably securing said storage system to a vehicle surface;
a lid;
a handle; and
a handle latch;
wherein said means for securing said storage system to a vehicle surface further comprises:
at least one attachment flange;
at least one mounting flange where the number of said mounting flanges is equal to the number of said attachment flanges; and
at least one removable mounting fastener where the number of said mounting fasteners is equal to the number of said attachment flanges;
wherein said base and said lid are connected along a common edge by a lid hinge;
wherein said attachment flanges are spaced evenly around and integrally attached to the sides of said base;
wherein each said attachment flange extends out from the side of said base;
wherein all said mounting flanges are attached directly to said vehicle surface;
wherein each said removable mounting fastener is used to connect one said attachment flange to one corresponding said mounting flange to form an integral assembly;
wherein said handle latch and said handle are both located on the side of said storage system opposite said lid hinge;
wherein said handle latch and said handle are both attached to the upper lip of said base by a common handle latch hinge; and
wherein said lid and said base are maintained in a closed position by said handle latch.

8. The storage system according to claim 1,
wherein said means for securing said storage system to a vehicle surface further comprises:
at least one attachment flange;
at least one mounting flange where the number of said mounting flanges is equal to the number of said attachment flanges; and
at least one removable mounting fastener where the number of said mounting fasteners is equal to the number of said attachment flanges;
wherein said attachment flanges are integrally attached to the bottom surface of said base;
wherein all said mounting flanges are permanently or temporarily attached directly to said vehicle surface; and
wherein each said removable mounting fastener is used to connect one said attachment flange to one corresponding said mounting flange to form an integral assembly.

9. The storage system according to claim 8,
wherein said mounting fastener comprises a thumbscrew.

10. The storage system according to claim 8,
further comprising:
a handle; and
a handle latch;
wherein said handle latch and said handle are both located on the side of said storage system opposite said lid hinge;
wherein said handle latch and said handle are both attached to the upper lip of said base by a common handle latch hinge; and
wherein said lid and said base are maintained in a closed position by said handle latch.

11. The storage system according to claim 8,
further comprising:
two handles; and
two handle latches;
wherein said handle latches and said handles are all located on the side of said storage system opposite said lid hinge;
wherein each said handle latch and one said handle are together attached to the upper lip of said base by a common handle latch hinge; and
wherein said lid and said base are maintained in a closed position by said handle latches.

12. The storage system according to claim 8,
wherein each said attachment flange is selected from the group consisting essentially of a female-threaded through-hole, an integral female-threaded nut and an unthreaded hole.

13. A storage system comprising:
a base including a means for removably securing said storage system to a vehicle surface;
a lid;
a handle; and
a handle latch;
wherein said means for securing said storage system to a vehicle surface further comprises:
at least one attachment flange;
at least one mounting flanges where the number of said mounting flanges is equal to the number of said attachment flanges; and
at least one removable mounting fasteners where the number of said mounting fasteners is equal to the number of said attachment flanges;
wherein said base and said lid are connected along a common edge by a lid hinge;
wherein said attachment flanges are integrally attached to the bottom surface of said base;
wherein all said mounting flanges are attached directly to said vehicle surface;
wherein each said removable mounting fastener is used to connect one said attachment flange to one corresponding said mounting flange to form an integral assembly;
wherein said handle latch and said handle are both located on the side of said storage system opposite said lid hinge;
wherein said handle latch and said handle are both attached to the upper lip of said base by a common handle latch hinge; and
wherein said lid and said base are maintained in a closed position by said handle latch.
